(19) United States
(12) Patent Application Publication
(10) Pub. No.: US 2024/0166113 A1
(43) Pub. Date: May 23, 2024

(54) CONTAINER WITH A MODULAR LID

(71) Applicant: Harry Ung, Rocklin, CA (US)

(72) Inventor: Harry Ung, Rocklin, CA (US)

(21) Appl. No.: 18/494,644

(22) Filed: Oct. 25, 2023

Related U.S. Application Data
(60) Provisional application No. 63/427,273, filed on Nov. 22, 2022.

(51) Int. Cl. B60N 3/08; B65F 1/16

(52) U.S. Cl. CPC B60N 3/08; B65F 1/1607; B65F 1/1623

(57) ABSTRACT

A container with a lid that can be used as a trash bin for use in vehicles, homes, and the like. The container is substantially rectangular having a flat rear side and a curved front side. The lid is also substantially rectangular having a linear rear side and curved front side. The lid has an elongated opening that is closed by a front flap and a rear flap forming a bi-folding lid. The rare flap is pivotally coupled to a rear side of the elongated opening and the front flap is pivotally coupled to a front side of the elongated opening. The front flap consists of a central part, a left part, and a right part.

### CROSS-REFERENCE TO RELATED APPLICATIONS

This application claims priority from a U.S. provisional patent application Ser. No. 63/427,273 filed on Nov. 22, 2022 which is incorporated herein by reference in its entirety.

### FIELD OF INVENTION

The present invention relates to a container with modular lid, more particularly, the present invention relates to a container with modular lid for use as a waste bin.

### BACKGROUND

Waste bins, also known as trash bins or garbage bins, are containers with lids that are used to store trash. The lids of waste bins make them different from other containers with lids used for storage. The lid of waste bins can be opened or partially opened without completely removing the lid and without the need for touching the lid. Typically, a lid is pivotally coupled that can be pivoted between an open state and a close state. For example, pedal operated trash bin have a pedal to actuate the pivoting mechanism. Although force is required to open the lid, the lid can close by itself.

Small trash bins are widely used in residential places, commercial places, public places, vehicles, and the like. Trash bins are used in vehicles, such as car for collecting the waste. The trash bins for vehicles can be coupled to any supporting structure in the vehicle such as to a seat of a car.

Most of the trash bins, however, suffer from a major drawback i.e., having smaller opening for putting the waste into the trash bin. Because of the pivoting action of the lid, there is lesser space to insert a waste item. This problem exaggerates in trash bins of smaller sizes. Because of smaller size opening in smaller trash bins, it becomes difficult to put a waste item into the trash bin.

A need is therefore appreciated for a novel design of trash bins which have a broader opening in the lid for putting the waste.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a curved profile trash bins with a modular lid that has a wider opening for putting waste into the bin.

It is another object of the present invention that the trash bin is compact in profile.

It is still another object of the present invention that the trash bin can be adapted for use in a vehicle.

It is yet another object of the present invention that the opening in the lid can automatically closed.

It is a further object of the present invention that the trash bin is economical to manufacture.

It is still a further object of the present invention that the opening of lid is wide enough to correspond to a width of the container.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the trash bin, according to an exemplary embodiment of the present invention.

FIG. 2 shows a lid of the trash bin separated from the container, according to an exemplary embodiment of the present invention.

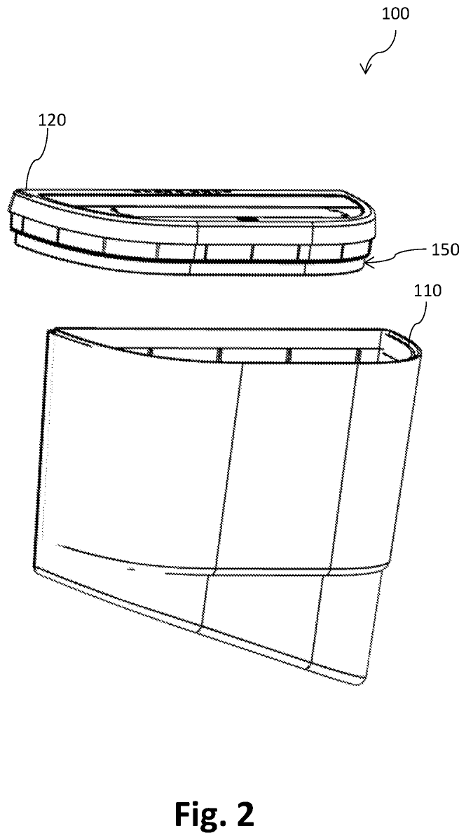

FIG. 3 is a rear perspective view of the container showing attachment of fasteners, according to an exemplary embodiment of the present invention.

FIG. 4 is an exploded view of the trash bin, according to an exemplary embodiment of the present invention.

FIG. 5 shows the front flap consisting of a central part and side parts, according to an exemplary embodiment of the present invention.

FIG. 6 shows attachment of damper, according to an exemplary embodiment of the present invention.

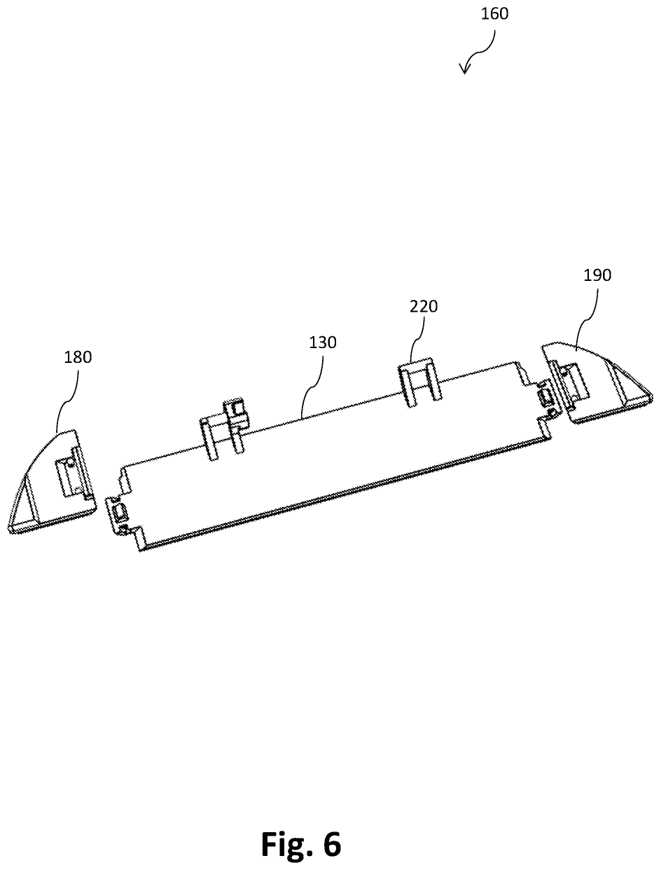

FIG. 7 shows a bottom view of the lid, according to an exemplary embodiment of the present invention.

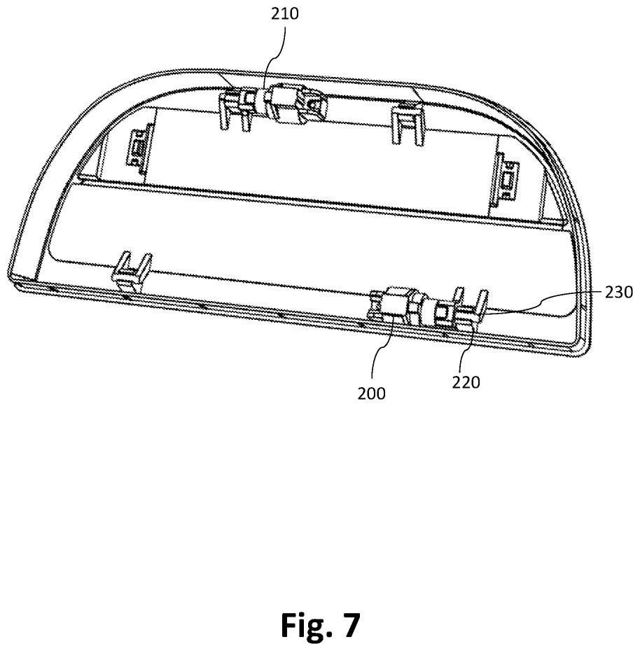

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

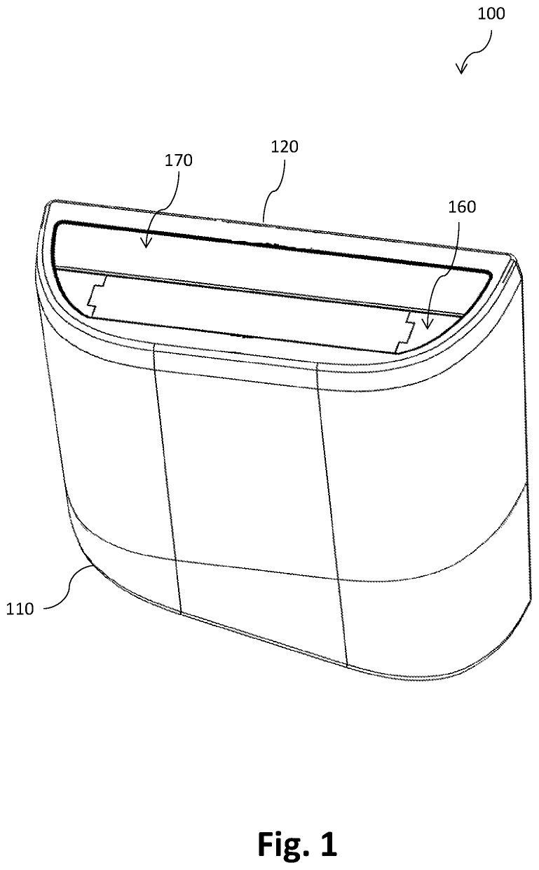

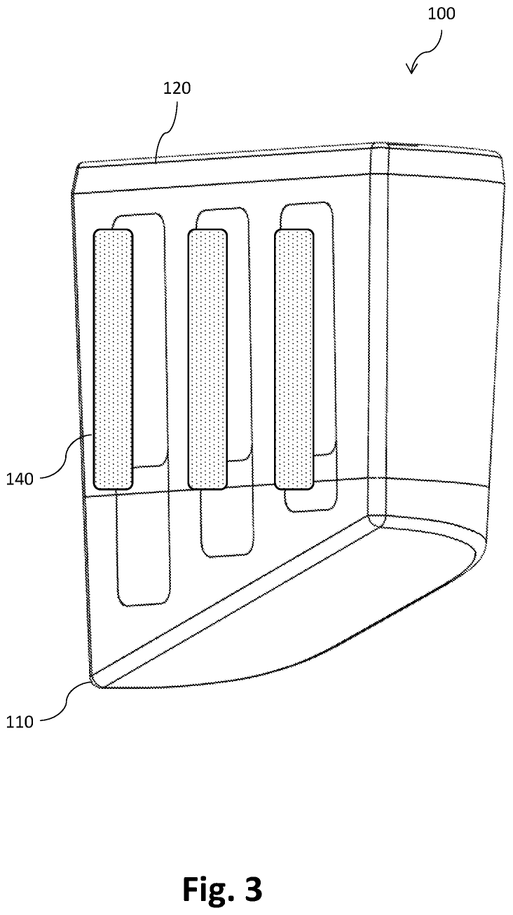

Referring to FIG. 1, disclosed is a trash bin 100 that include a container 110 and a lid 120. The container includes a base and wall upstanding from the base, wherein the base and the wall define an interior volume of the container. The container has an open top that is covered by the lid. The container can be manufactured in a range of shapes and sizes. Preferably the containers can be wider rather than cylindrical. For example, the container to be mounted to a flat surface can have at least one side flat. FIG. 1 shows the container of trash bin having a flat rear side that can be mounted to a seat of a vehicle. The container can be manufactured in a range of sizes for different capacities. The container can be manufactured from a suitable materials, such as plastic and metal. Preferably, light weight materials such as plastic, aluminum, and tin can be used. The container can be manufactured in a range of colors, and a variety of designs can also be engraved or applied to the container. The container can also be provided with suitable fasteners for mounting the trash bin to a supporting structure. For example, hook tape 140 can be applied to the rear side of container 110, wherein the hook tapes can embed to a supporting fabric surface for mounting the trash bin. FIG. 3 shows three hook tapes that can be attached to rear face of the container for mounting the trash bin to a seat of the vehicle.

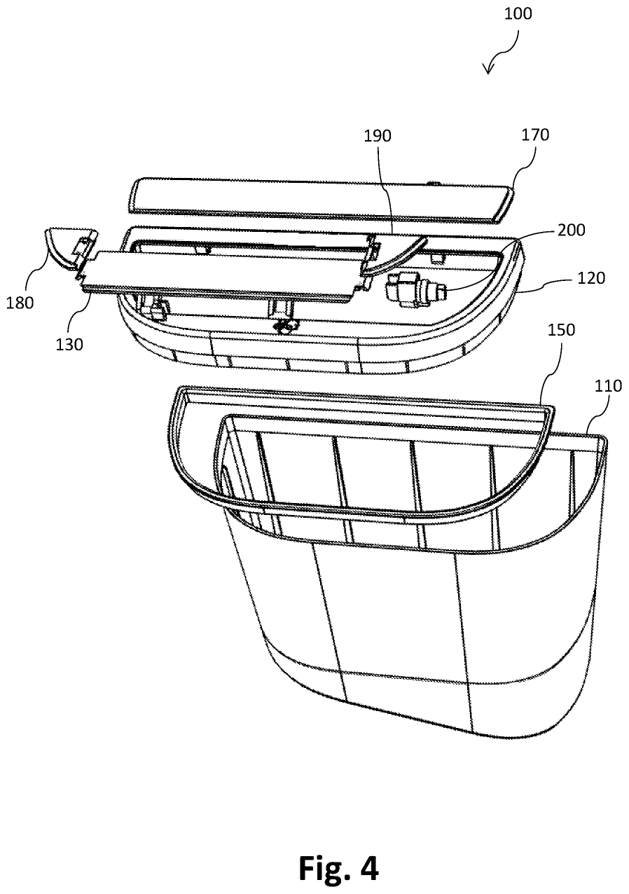

The lid closes the open top of the container. Liner 150 can be sandwiched between the inner periphery of the lid and open top of the container for firmly securing the lid to the container. FIG. 4, which is an exploded view shows the liner 150. The lid can be secured to the container through a variety of fastening mechanism, such as snap fit mechanism, friction fit mechanism, or using hooks. Any fastening mechanism for attaching the lid to the container is within the scope of the present invention. The lid can be opened to dispose of the garbage from the trash bin.

For putting the garbage into the trash bin, the lid has an opening in its central section. Through this opening, the waste item can be dropped/inserted into the trash bin. This opening in the lid can be closed by a set of flaps which engage to close the opening and disengage to open the opening.

The set of flaps includes a front flap 160 and a rear flap 170, the front flap is along the front curved side of the container and the rear flap is along the rear flat side of the container. The rear flap is pivotally coupled to the rear side of the lid. The rear flap can close almost half of the opening in the lid, wherein the rear flap can pivot downwards to provide access into the container. A first damper 200 can be used to bias the rear flap in a closed state. The structure and function of the damper is described below.

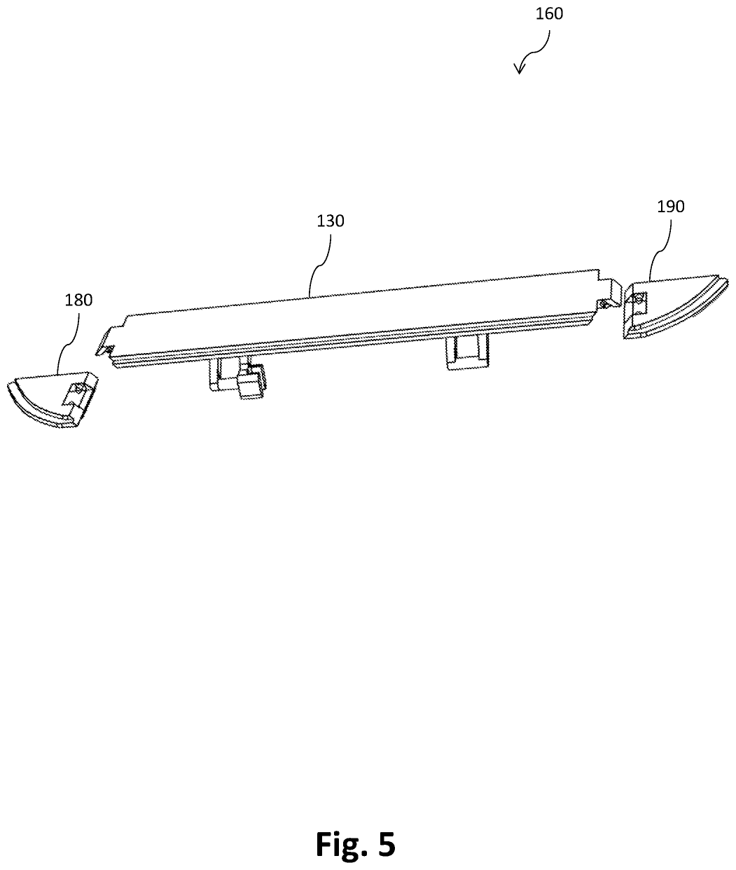

Referring to FIG. 5, the front flap 160 consists of three parts, a central part 130, a left part 180, and a right part 190. The central part is pivotally coupled to the front portion of the lid. The left part is pivotally coupled to a left side of the central part and the right part is pivotally coupled to a right side of central part. A second damper 210 can bias the central part in the closed state.

The front flap and the rear flap form a bi-fold lid that opens downwards, and the waste can be deposited from the top of the lid. Slight force downwards on the flaps causes the bi-fold lid to open, and the waste is received into the container.

Waste is deposited into the bin from the top by way of a bi-fold lid. The disclosed modular bi-fold lid is particularly suitable for curved containers as shown in the drawings. The curved shape provides aesthetics and aids in limiting the footprint in the vehicle while allowing for sufficient waste storage. Because of this curved shape, the front flap which is along the curved side is designed differently from the rear flap. The side parts of the front flap can fold perpendicular to the main axis of rotation of the central part. This allows maximum access to the inside of the trash bin. The side flaps can be coupled to the central part using suitable brackets that allows the side flaps to pivot upwards but not downwards. The brackets can limit the rotation of side parts relative to the central part.

As shown in the drawings, the front flap can be substantially rectangular in shape with rounded corners so to match the lid opening's periphery. The central part can be rectangular in shape. The edges of the left part and the right part that are adjacent to the rear flap and the central part can be linear.

The drawings show the inner surface of the lid can include a bracket 220 and the flaps can include a stem 230, wherein the stem can rotatably snap fit into the bracket. It is to be understood that any another mechanism for mounting the rear flap and the central part to the lid can be incorporated without departing from the scope of the present invention.

The drawings show a damper mount that is coupled to the lid and the flaps, the damper mount allows for mounting a damper. The damper may be spring based that allow biasing the flaps in the closed state. The dampers can allow soft closure of the flaps. One of the bracket can be modified to mount the damper.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A trash bin comprises:
a container of substantially rectangular shape, a rear side of the container is flat, a front side of the container is curved;
a lid of a substantially rectangular shape, a rear side of the lid is linear and a front side is curved, the front side of the lid is along the curved front side of the container, the lid has an elongated opening;
a rare flap pivotally coupled to a rear side of the elongated opening; and
a front flap pivotally coupled to a front side of the elongated opening, the front flap comprises a central part, a left part, and a right part.

2. The trash bin according to claim 1, wherein the rear side of the opening is linear in shape, wherein a left side, the front side, a right of the elongated opening are curved.

3. The trash bin according to claim 1, wherein the central part is rectangular, each of the left part and the right part has one curved side.

4. The trash bin according to claim 3, wherein the left part is pivotally coupled to a left side of the central part, and the right part is pivotally coupled to a right side of the central part.

5. The trash bin according to claim 4, wherein the trash bin comprises:
a first damper coupled to the lid and the rear flap, wherein the first damper configured to bias the rear flap in a closed state; and
a second damper coupled to the lid and the central part of the front flap, wherein the second damper configured to bias the front flap in a closed state.
